(19) United States
(12) Patent Application Publication
(10) Pub. No.: US 2018/0329910 A1
(43) Pub. Date: Nov. 15, 2018

(54) SYSTEM FOR DETERMINING COMMON INTERESTS OF VEHICLE OCCUPANTS

(71) Applicant: Faraday&Future Inc., Gardena, CA (US)

(72) Inventors: Matthew Joseph Coburn, Milford, MI (US); Nicholas William Dazé, Manhattan Beach, CA (US)

(73) Assignee: Faraday&Future Inc., Gardena, CA (US)

(21) Appl. No.: 15/772,509

(22) PCT Filed: Oct. 28, 2016
(86) PCT No.: PCT/US2016/059290

§ 371 Date: Apr. 30, 2018

Related U.S. Application Data
(60) Provisional application No. 62/248,462, filed on Oct. 30, 2015.

(51) Int. Cl. G06F 17/30; H04L 29/08; H04W 8/00

(52) U.S. Cl. CPC G06F 17/30035; G06F 17/3005; H04W 8/005; H04L 67/306; G06F 17/30058

(57) ABSTRACT

A system for determining common interests of vehicle occupants may include an interface and a processing unit, The interface may be configured to access a first set of data related to a first person occupying the vehicle and a second set of data related to a second person occupying the vehicle. The processing unit may be configured to compare the first set of data with the second set of data to determine data commonalities. The processing unit may also be configured to request and receive related data having at least one common characteristic of the determined data commonalities, and output the related data.

### TECHNICAL FIELD

The present disclosure relates generally to a system for determining common interests, and more particularly, to a system for determining common interests of vehicle occupants and selecting data based on the common interests.

### BACKGROUND

There are many situations that arise when a group of people have unique interests, share a common space, and are the audience of common media. For example, a ride sharing situation often results in a group of people occupying an interior of a vehicle and being exposed to a type of entertainment selected on a single audio or video system. However, the occupants may have different preferences. For example, one person may prefer classic rock, may have a neutral attitude to talk radio, and may not favor classical music. While another occupant may prefer talk radio, may have a neutral attitude to classical music, and may not favor classic rock.

In such situations, there are many reasons that may prevent the group from reaching a mutually acceptable entertainment selection. In some instances, there may be social barriers to achieving a mutually acceptable selection, such that the group may not be familiar with each other's interests and/or the people may be too polite to express their preferences. In some instances, one occupant may have physical access to the controls, while the controls may not be accessible to the others. In addition, the group may not be aware of available media that would satisfy their common interests. This problem may cause an uncomfortable situation for at least one person and may even cause an argument.

The disclosed system may mitigate or overcome one or more of the problems set forth above and/or other problems in the prior art.

### SUMMARY

One aspect of the present disclosure is directed to a system for determining common interests of vehicle occupants. The system may include an interface and a processing unit. The interface may be configured to access a first set of data related to a first person and a second set of data related to a second person. The processing unit may be configured to compare the first set of data with the second set of data to determine data commonalities. The processing unit may also be configured to request and receive related data having at least one common characteristic of the determined data commonalities, and output the related data.

Another aspect of the present disclosure is directed to a vehicle. The vehicle may include a system for determining common interests of vehicle occupants. The system may have an interface and a processing unit. The interface may be configured to access a first set of data related to a first person occupying the vehicle and a second set of data related to a second person occupying the vehicle. The processing unit may be configured to compare the first set of data with the second set of data to determine data commonalities. The processing unit may also be configured to request and receive related data having at least one common characteristic of the determined data commonalities, and output the related data.

Yet another aspect of the present disclosure is directed to a method for determining common interests of vehicle occupants with a system having an interface and a processing unit. The method may include accessing, with the interface, a first set of data related to a first person and a second set of data related to a second person. The method may also include comparing, with the processing unit, the first set of data with the second set of data to determine data commonalities. The method may further include requesting and receiving, with the processing unit, related data having at least one common characteristic of the determined commonalities, and outputting, with the processing unit, the related data.

### BRIEF DESCRIPTION OF THE DRAWINGS

FIG. 1 is a diagrammatic illustration of an exemplary embodiment of an interior of an exemplary vehicle.

FIG. 2 is a block diagram of an exemplary system that may be used with the exemplary vehicle of FIG. 1 according to an exemplary embodiment.

FIG. 3 is a flowchart illustrating an exemplary process that may be performed by the exemplary system of FIG. 2 according to an exemplary embodiment.

### DETAILED DESCRIPTION

The disclosure is generally directed to a system that determines common interests of a group of people. In some embodiments, the system may facilitate identifying commonly appealing entertainment types for the occupants of a multi passenger vehicle. The system may be applied to any type of vehicle, such as boats, buses, trains, planes, and automobiles. In some embodiments, the system may have non-entertainment based applications, such as determining destinations and vehicle settings of a multi passenger vehicle. For example, the system may be applied to determining a type of restaurant that satisfies data commonalities of the occupants. The system may also be applied to determining HVAC settings according to commonly preferred temperature settings. In some embodiments, the system may also have non-vehicle applications, such as accessing entertainment for restaurants, businesses, and homes.

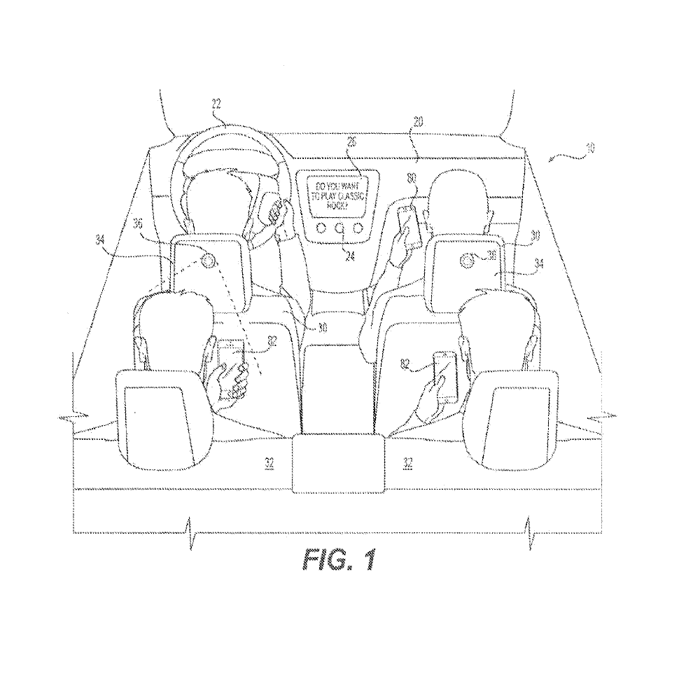

FIG. 1 is a diagrammatic illustration of an exemplary embodiment of an exemplary vehicle 10. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous. As illustrated in FIG. 1, vehicle 10 may have a dashboard 20 through which a steering wheel 22, an audio system 24, and a user interface 26 may project. Vehicle 10 may also have one or more front seats 30 and one or more back seats 32 configured to accommodate occupants. Vehicle 10 may further include one or more cameras 36 positioned to capture images including facial features of the occupants. For example, a camera 36 may be positioned on the back of a headrest 34 of a front seat 30 to capture images of occupants in a back seat 32.

User interface 26 may be configured to receive input from the user and transmit data. For example, user interface 26 may have a display including an LCD, an LED, a plasma display, or any other type of display, and provide a graphical user interface (GUI) presented on the display for user input and data display. User interface 26 may further include input devices, such as a touchscreen, a keyboard, a mouse, and/or a tracker ball. User interface 26 may further include a housing having grooves containing the input devices and configured to receive individual fingers of the user. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display other media, such as movies and/or television.

User interface 26 may be configured to receive user-defined settings. For example, user interface 26 may be configured to receive occupant profiles including individual preferences, for example, of media and destinations. In some embodiments, user interface 26 may include a touch-sensitive surface that may be configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by a controller. The controller may be configured to compare the signal to stored data to determine whether the fingerprint matches recognized occupants. User interface 26 may be configured to include biometric data into a signal, such that the controller may be configured to identify the person who is generating an input. Furthermore, user interface 26 may be configured to store data history accessed by the identified people.

Camera 36 may include any device configured to capture videos or images of the interior of vehicle 10 and generate a signal to be processed to visually detect the presence of occupants of vehicle 10. For example, camera 36 may be used in conjunction with image recognition software, such that the software may distinguish a person from inanimate objects, and may recognize certain people based on physical appearances. In some embodiments, the image recognition software may include facial recognition software and may be configured to determine an age (e.g., by determining size and facial appearances) and a mood (e.g., by determining facial expressions, skin tone, and other physical indicators) of occupants based on the videos or the images. For example, facial recognition software may be configured to determine preferences of the occupant based on reactions to outputted data.

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be programmed to be associated with users associated with vehicle 10. For example, vehicle 10 may be configured to determine the presence of specific people based on a digital signature from mobile communication devices 80, 82. For instance, a controller may be configured to relate the digital signature to stored data including the person's name and the person's relationship with vehicle 10. The digital signature of mobile communication devices 80, 82 may include a determinative emitted radio frequency (RF) or a GPS tag. Mobile communication devices 80, 82 may be configured to automatically connect to vehicle 10 through local network 70, e.g., Bluetooth™ or WiFi, when positioned within a proximity (e.g., within vehicle 10).

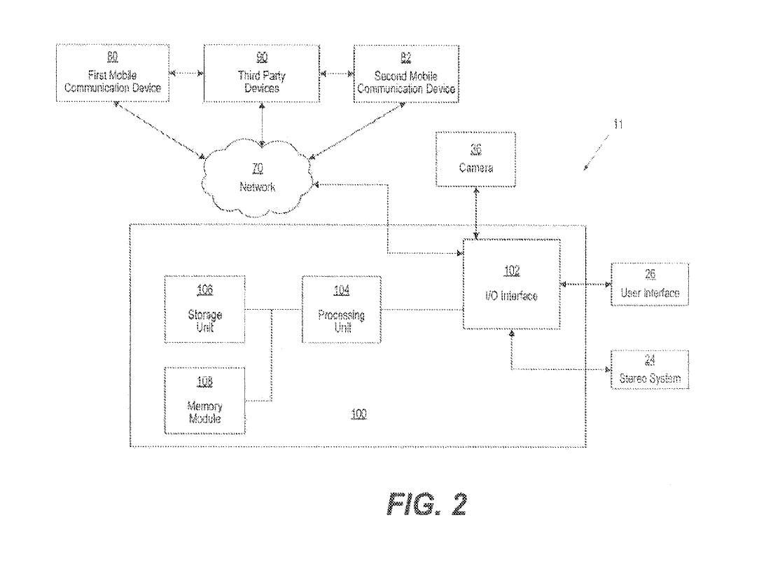

FIG. 2 provides a block diagram of an exemplary system 11 that may be used in accordance with a method of determining common interests. As illustrated in FIG. 2, system 11 may include a controller 100 having, among other things, an I/O interface 102, a processing unit 104, a storage unit 106, and a memory module 108. One or more of the components of controller 100 may be installed in an on-board computer of vehicle 10. These units may be configured to transfer data and send or receive instructions between or among each other.

I/O interface 102 may also be configured for two-way communication between controller 100 and various components of system 11, such as audio system 24, user interface 26, and camera 36. I/O interface 102 may also send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include websites and/or servers of third parties (e.g., iTunes™, Pandora™, Google™, Facebook™, and Yelp™) that provide access to content and/or stored data (e.g., media and search histories) associated with the users. Third party devices 90 may include websites and servers (e.g., iTunes™ and Spotify™) that enable accessing and/or downloading media such as music, television shows, and/or movies. Third party devices 90 may also be search engines (e.g., Google™) that receive search requests, such as locations of restaurants or movie times. Third party devices may also include social media content (e.g., Facebook™ and Yelp™) that allows users to express opinions or provide reviews. Third party devices 90 may be accessible to the users through mobile communication devices 80, 82 or directly accessible by controller 100, via I/O interface 102, according to respective authorizations of the user. For example, users may allow controller 100 to receive content from third party devices by configuring settings of accounts with third party devices 90 or settings of mobile communication devices 80, 82.

Processing unit 104 may be configured to receive signals and process the signals to determine a plurality of conditions of the operation of vehicle 10. Processing unit 104 may also be configured to generate and transmit command signals, via I/O interface 102, in order to actuate the devices in communication.

In some embodiments, processing unit 104 may be configured to determine the presence of people within an area, such as occupants of vehicle 10. Processing unit 104 may be configured to determine the identity of the occupants through a variety of mechanisms. For example, processing unit 104 may be configured to determine the presence of specific people based on a digital signature from mobile communication devices 80, 82. For instance, processing unit 104 may be configured to relate the digital signature to stored data including the person's name and the person's relationship with vehicle 10. The digital signature of communication device 80 may include a determinative emitted radio frequency (RF), GPS, Bluetooth™, and/or WiFi unique identifier. Processing unit 104 may also be configured to determine the presence of people within vehicle 10 by GPS tracking software of mobile communication devices 80, 82. In some embodiments, vehicle 10 may be configured to detect mobile communication devices 80, 82 by mobile communication devices 80, 82 connecting to local network 70 (e.g., Bluetooth™ or WiFi). Processing unit 104 may also be configured to recognize occupants of vehicle 10 by receiving inputs into user interface 26. For example, user interface 26 may be configured to receive direct inputs of the identities of the occupants. User interface 26 may also be configured to receive biometric data (e.g., fingerprints) from occupants when manipulating user interface 26. Processing unit 104 may be further configured to recognize occupants by facial recognition software used in conjunction with cameras 36.

In some embodiments, processing unit 104 may be configured to access and collect sets of data related to the people within the area in a number of different manners. Processing unit 104 may be configured to store the sets of data in a database. In some embodiments, processing unit 104 may be configured to access sets of data stored on mobile communication devices 80, 82, such as apps, audio files, text messages, notes, and messages. Processing unit 104 may also be configured to access accounts associated with third party devices 90, by either accessing the data through mobile communication devices 80, 82 or directly accessing the data from third party devices 90. Processing unit 104 may be configured to receive data directly from occupants, for example, through access of user interface 26. For example, occupants may be able to directly input vehicle settings, such as a desired internal temperature. Processing unit 104 may also be configured to receive data from history of previous inputs of the occupant into user interface 26. Processing unit 104 may be further configured to access data from expressions of occupants through images captured by cameras 36. For example, processing unit 104 may be configured to execute facial recognition software to determine the occupant's interest in the media currently being played in vehicle 10.

Processing unit 104 may be configured to extract data from the collected sets of data to determine the occupant's interests and store the extracted data in a database. For example, processing unit 104 may be configured to associate stored music files to a song, an artist, and/or genre of music. Processing unit 104 may also be configured to determine favorite restaurants or types of food through occupant search histories or Yelp™ reviews. Processing unit 104 may be configured to store data related to previous destinations of an occupant using vehicle 10. Processing unit 104 may further be configured to execute character recognition software to determine the contents of messages or posts of occupants on social media to recognize keywords related to interests.

Processing unit 104 may be configured to compile and/or update profiles including interests based on the collected sets of data. Processing unit 104 may be configured to store the profiles in the database. In compiling/updating the profiles, processing unit 104 may be configured to generate and associate a weight to one or more of the interests of the occupant. The interests may be weighted based on a number of different aspects. In some embodiments, the interests may be weighted based the quantity and types of data collected. For example, an interest of a certain song or artist may be provided a factor based on the number of music files associated with that artist. The more music files related to the artist may correlate to a stronger interest, such that the interest may receive a larger weight. The factor may also be determined based on the contents of the collected data, such as the occupant giving a restaurant five stars on Yelp™. In some embodiments, the processing unit 104 may be configured to divide the profile into distinct categories, such as “interests”, “impartial”, and “disinterests” based on the degree of perceived interest.

Processing unit 104 may be configured to compare (e.g., cross-reference) the compiled profiles for one or more of the people within vehicle 10. In some embodiments, processing unit 104 may be configured to compare the compiled profiles to determine which inputs are common to each of the profiles. Processing unit 104 may then be configured to determine a data commonality based on it being an interest of a predetermined percentage of occupants. For example, in some embodiments, processing unit 104 may require that all (100%) of the occupants share a data commonality. However, in some embodiments, processing unit 104 may require less than 100% of the occupants to share an interest to create a data commonality. It is also contemplated that processing unit 104 may disregard an interest if it is categorized as a “disinterest” category. In some embodiments, processing unit 104 may be configured to compare the compiled profiles by calculating a weighted sum of the interests of the profiles. For example, processing unit 104 may accumulate the interests of each of the people based on a factor of each of the interests. Processing unit 104 may then be configured to select data commonalities based on the interests achieving a predetermined weighted sum.

In determining data commonalities, processing unit 104 may also be configured to consider environmental elements inside and/or outside of vehicle 10. For example, when determining data commonalities of the vehicle settings (e.g., HVAC), processing unit 104 may be configured to determine whether the interior and/or exterior conditions are within a predetermined comfortable range, and whether a change in the interior climate is necessary. Processing unit 104 may also be configured to consider the geographic positioning of vehicle 10. For example, processing unit 104 may be configured to determine the relative location of restaurants that would satisfy the data commonalities of the group. For instance, if the group has Mexican and Italian food as common interests, processing unit 104 may be configured to weight the relative locations of restaurants that serve Mexican and Italian foods.

Processing unit 104 may also be configured to thereafter request and output related data having at least one common characteristic of a data commonality. In some embodiments, processing unit 104 may be configured to access and output data from mobile communication devices 80, 82 based on the data commonality. For example, processing unit 104 may be configured to access song titles determined to be a data commonality from a hard drive of mobile communication devices 80, 82. In some embodiments, processing unit 104 may be configured to access data from third party devices 90 based on the data commonality. For example, processing unit 104 may be configured to request data related to the data commonality, such as song titles from the same genre as a determined data commonality. In some embodiments, processing unit 104 may be configured to access and output locations of restaurants that may have at least one common characteristic of a data commonality. Processing unit 104 may be configured to output the related data via speakers of stereo system 24 and/or user interface 26.

Storage unit 106 and/or memory module 108 may be configured to store one or more computer programs that may be executed by controller 100 to perform functions of system 11. For example, storage unit 106 and/or memory module 108 may be configured to store biometric data detection and processing software configured to determine the identity of people based on fingerprint(s) and image recognition software configured to relate images to identities of people. Storage unit 106 and/or memory module 108 may be further configured to store data and/or look-up tables used by the processing unit. For example, storage unit 106 and/or memory module 108 may be configured to include data related to individualized profiles of people related to vehicle 10.

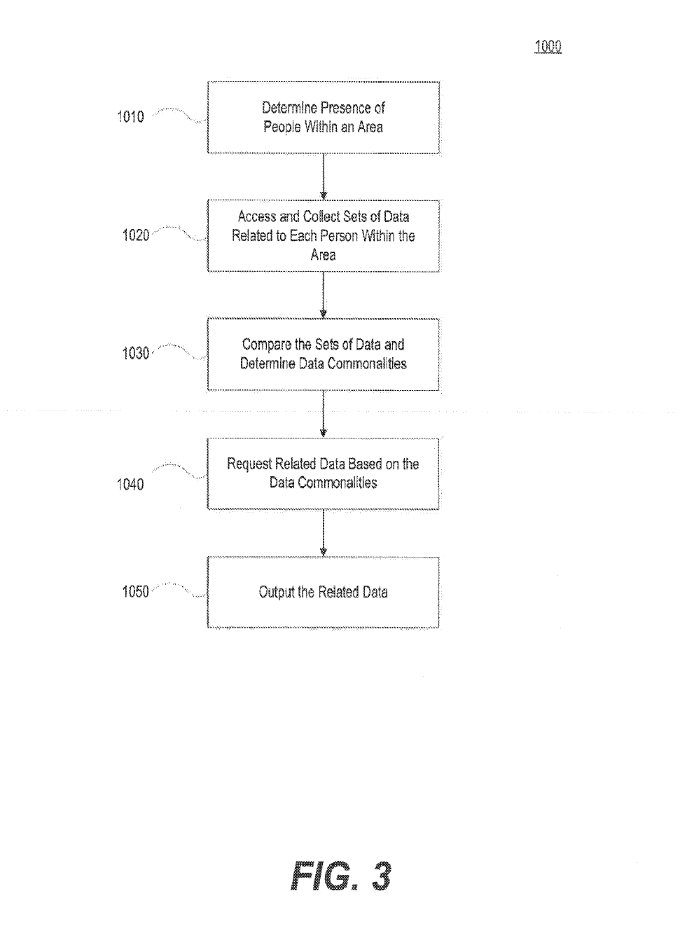

FIG. 3 is a flowchart illustrating an exemplary process 1000 that may be performed by exemplary system 11 of FIG. 2.

In Step 1010, one or components of system 11 may determine the presence of people within an area. For example, as illustrated in FIG. 1, processing unit 104 may determine the number of occupants within vehicle 10 and their identities. The determination may be made according to mobile communication devices 80 connected to a local wireless network (e.g., Bluetooth™) of vehicle 10. The determination may also be made according to manual entry of data into vehicle 10, for example, occupants selecting individual names through user interface 26. Processing unit 104 may also collect biometric data (e.g., fingerprint data) from the occupant. Processing unit 104 may further make the determination by executing to image recognition software based on images from cameras 36.

In Step 1020, one or components of system 11 may access and collect sets of data related to each person within the area. Processing unit 104 may determine whether the identified people have stored profiles. Processing unit 104 may also access sets of data stored on mobile communication device 80, 82 and third party devices 90 to update the stored profile. If the occupant does not have a stored profile, processing unit 104 may generate a profile based on the accessed data. For example, processing unit 104 may determine the interests of one or more (e.g., each) of the occupants of vehicle 10. Processing unit 104 may determine each of the occupant's preferences, for example, in audio, movies, and food. Processing unit 104 may determine genres of music based categories, such as “interests”, “impartial”, and “disinterests” according a degree of determined interest. Processing unit 104 may also determine food preferences of each of the occupants.

In Step 1030, one or more components of system 11 may compare sets of data and determine data commonalities. For example, processing unit 104 may determine which genres of music are among the preferences of each of the occupants. Processing unit 104 may disregard a genre based on it being listed as a “disinterest” among one or more of the occupants. Processing unit 104 may also determine the data commonalities based on weighted factors of each of the interests and a weighted sum of the collective interests of the occupants.

In Step 1040, one or more components of system 11 may request related data having at least one common characteristic of the data commonalities. For example, processing unit 104 may request audio files having a genre determined to be a data commonality of the occupants. Processing unit 104 may also request locations of restaurants that serve a type of food of common food preferences of the occupants.

In Step 1050, one or more components of system 11 may output the related data. The output of the related data may be in response to a request from one of the occupants. In some embodiments, the output of the related data may include a suggestion or a prompt, such as “DO YOU WANT TO PLAY CLASSIC ROCK MUSIC?” In some embodiments, processing unit 104 may automatically output the related data, such as playing classic rock music. When determining data commonality of destinations (e.g., related to food), system may provide directions to restaurants that match common food preferences of the occupants.

Even though discussed in relation to vehicle 10, system 11 and method 1000 may be applied to many other group environments, such as businesses and restaurants. For example, system 11 may be configured to access and collect a variety data related to patrons of a restaurant and determine data commonalities of the patrons. System 11 may then determine and output music, entertainment, or other related data based on the data commonalities.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed systems and related methods. Other embodiments will be apparent to those skilled in the art from consideration of the specification and practice of the disclosed systems and related methods. It is intended that the specification and examples be considered as exemplary only, with a true scope being indicated by the following claims and their equivalents.

What is claimed is:

1. A system for determining common interests of vehicle occupants, the system comprising:
an interface configured to:
access a first set of data related to a first person; and
access a second set of data related to a second person; and
a processing unit configured to:
compare the first set of data with the second set of data to determine data commonalities;
request and receive related data having at least one common characteristic of the determined data commonalities; and
output the related data.

2. The system of claim 1, wherein the first and second sets of data are based on at least one of media, a destination, and vehicle settings.

3. The system of claim 1,
wherein the interface is further configured to receive a first signature signal from a first mobile communication device associated with the first person and a second signature signal from a second mobile communication device associated with the second person, and
wherein the processing unit is further configured to determine the presence of the first person based on the first signature signal and determine the presence of the second person based on the second signature signal.

4. The system of claim 1, wherein the processing unit is configured to access the first and second sets of data from the first and second mobile communication devices.

5. The system of claim 1, wherein the processing unit is configured to access the first and second sets of data from one or more third party systems through respective authorizations.

6. The system of claim 1, wherein the processing unit is configured to extract data from the first and second sets of data and store the extracted data in a database, and wherein the data commonalities are based on the extracted data.

7. The system of claim 6, wherein the processing unit is configured to at least one of: classify the extracted data based on preferences or apply a weight factor to the extracted data according to the preferences.

8. The system of claim 1, wherein the processing unit is configured to request and receive the related data from a third party system.

9. The system of claim 1, further comprising a camera configured to capture an image of at least one of the first and second people and generate a signal,
wherein the processing unit is further configured to process the signal with facial recognition software to determine a reaction of the at least one of the first and second people, and wherein the data commonalities are based on the reaction.

10. A vehicle comprising:
a system for determining common interests of vehicle occupants, the system comprising:
an interface configured to:
access a first set of data related to a first person occupying the vehicle; and
access a second set of data related to a second person occupying the vehicle; and
a processing unit configured to:
compare the first set of data with the second set of data to determine data commonalities;
request and receive related data having at least one common characteristic of the determined data commonalities; and
output the related data.

11. The vehicle of claim 10, wherein the first and second sets of data are based on at least one of media, a destination, and vehicle settings.

12. The vehicle of claim 10,
wherein the interface is further configured to receive a first signature signal from a first mobile communication device associated with the first person and a second signature signal from a second mobile communication device associated with the second person, and
wherein the processing unit is further configured to determine the presence of the first person based on the first signature signal and determine the presence of the second person based on the second signature signal.

13. The vehicle of claim 10, wherein the processing unit is configured to access the first and second sets of data from the first and second mobile communication devices.

14. The vehicle of claim 10, wherein the processing unit is configured to access the first and second sets of data from one or more third party systems through respective authorizations.

15. The vehicle of claim 10, wherein the processing unit is configured to extract data from the first and second sets of data and store the extracted data in a database, and wherein the data commonalities are based on the extracted data.

16. The vehicle of claim 15, wherein the processing unit is configured to at least one of: classify the extracted data based on preferences or apply a weight factor to the extracted data according to the preferences.

17. The vehicle of claim 10, wherein the processing unit is configured to request and receive the related data from a third party system.

18. The vehicle of claim 10, wherein the system further comprises a camera configured to capture an image of at least one of the first and second people and generate a signal,
wherein the processing unit is further configured to process the generated signal with facial recognition software to determine a reaction of the at least one of the first and second people, wherein the data commonalities are based on the reaction.

19. The vehicle of claim 10, wherein the processing unit is configured to request and receive the related data further based on the geographic location of the vehicle.

20. A method for determining common interests of vehicle occupants with a system having an interface and a processing unit, the method comprising:
accessing, with the interface, a first set of data related to a first person and a second set of data related to a second person;
comparing, with the processing unit, the first set of data with the second set of data to determine data commonalities;
requesting and receiving, with the processing unit, related data having at least one common characteristic of the determined data commonalities; and
outputting, with the processing unit, the related data.
